(19) United States
(12) Patent Application Publication
(10) Pub. No.: US 2022/0359872 A1
(43) Pub. Date: Nov. 10, 2022

(54) ALKALINE METAL SECONDARY BATTERY AND USES THEREOF

(71) Applicants: FRAUNHOFER-GESELLSCHAFT ZUR FÖRDERUNG DER ANGEWANDTEN FORSCHUNG E. V., München (DE); TECHNISCHE UNIVERSITÄT DRESDEN, Dresden (DE)

(72) Inventors: Felix HIPPAUF, Dresden (DE); Susanne DÖRFLER, Dresden (DE); Holger ALTHUES, Dresden (DE); Stefan KASKEL, Dresden (DE); Jonas PAMPEL, Dresden (DE); Luise BLOI, Dresden (DE)

(73) Assignees: FRAUNHOFER-GESELLSCHAFT ZUR FÖRDERUNG DER ANGEWANDTEN FORSCHUNG E. V., München (DE); TECHNISCHE UNIVERSITÄT DRESDEN, Dresden (DE)

(21) Appl. No.: 17/619,753

(22) PCT Filed: Jun. 16, 2020
(86) PCT No.: PCT/EP2020/066570

§ 371 Date: Dec. 16, 2021

(30) Foreign Application Priority Data
Jun. 18, 2019 (DE) 10 2019 208 843.0

(51) Int. Cl. H01M 4/587; H01M 10/0525; H01M 10/054; H01M 4/62; H01M 10/0562; H01M 4/38

(52) U.S. Cl. CPC H01M 4/587; H01M 10/0525; H01M 10/054; H01M 4/624; H01M 4/623; H01M 10/0562; H01M 4/381; H01M 2004/027

(57) ABSTRACT

The invention relates to alkaline secondary batteries. The secondary battery contains a cathode, an anode and an electrolyte, said secondary battery being arranged between the cathode and anode and comprises an alkali metal ion conductive contact to the cathode and to the carbon layer of the anode. The anode contains or consists of a carbon layer, whereby the carbon layer, alone or in combination with an electrically conductive substrate, forms with an electrically conductive contact.

An alkali metal secondary battery is provided. The secondary battery comprises a cathode, an anode and an electrolyte which is arranged between the cathode and anode and has an alkali metal ion-conductive contact to the cathode and to the carbon layer of the anode. The anode comprises or consists of a carbon layer, the carbon layer alone, or in combination with an electrically conductive substrate, forming an electrically conductive contact. The secondary battery is characterized in that the carbon layer comprises pores of a first type which are not accessible to the electrolyte and which are suitable for taking up electrochemically deposited alkali metal in metallic form during a charging process of the alkali metal secondary battery. The alkali metal secondary battery is characterized by very high specific capacity, high power density, high cycle stability, high long-term stability and high operational reliability.

Increasing the energy density of battery cells is a worldwide goal of research and development, among other things, for increasing the range of electric vehicles. The focus is on solid-state batteries, as it is expected that the solid electrolytes allow the safe and stable operation of metallic lithium anodes, thus being able to replace thicker and heavier graphite anodes.

However, there are still many challenges associated with the use of lithium as an anode. There is a 2-dimensional interface to the electrolyte in the cell, through which interface the ions diffuse during the charging and discharging process. The reversible mass transport of lithium ions without the formation of pores or dendrites at the interface and thus without the formation of mechanical stresses on the cell, in particular on its solid electrolyte, is only possible with low charging currents, increased temperatures and high pressure on the cell stack. These conditions have so far drastically restricted the area of application. This problem has not yet been solved. Solid-state batteries have not yet been produced on an industrial scale for this reason.

It is known that solid-state batteries having graphite anodes can be operated stably. However, their specific capacity is limited to 372 mAh/g (intercalation mechanism of lithium in graphite).

Based on this, it was the object of the present invention to provide an alkali metal secondary battery characterized by high specific capacity, high power density and high cycle stability and, during its operation, the lowest possible mechanical stresses acting on the components of the secondary battery, so that the battery's long-term stability and operational safety is increased.

The object is achieved by the lithium secondary battery having the features of claim 1 and the use according to claim 16. The dependent claims show advantageous developments.

According to the present invention, there is provided an alkali metal secondary battery comprising
a) a cathode;
a) an anode comprising or consisting of a carbon layer, the carbon layer, alone or in combination with an electrically conductive substrate, forming an electrically conductive contact; and
b) an electrolyte arranged between the cathode and anode and having an alkali metal ion-conductive contact to the cathode and to the carbon layer of the anode;

characterized in that the carbon layer comprises pores of a first type which are not accessible to the electrolyte and which are suitable for taking up electrochemically deposited alkali metal in metallic form during a charging process of the alkali metal secondary battery.

The term “carbon layer” means in particular a layer that consists of electrically conductive carbon materials selected from the group consisting of porous carbon, carbon black, graphene, graphite, graphite-like carbon (GLC), carbon fibers, carbon nanofibers, carbon hollow spheres and mixtures or combinations thereof.

The preferred specific features of the “carbon layer” (for example, pore volume, specific density, pore size etc.) thus relate to a layer that consists only of carbon. In principle, this carbon layer can of course comprise other substances (for example, binders and/or alkali metal). If, for example, the carbon layer comprises further substances (for example, in its pores of the second type), the specific characteristics may deviate from the ranges given here.

The alkali metal secondary battery has the advantage that it is not only characterized by a very high specific capacity and high power density, but rather, very low mechanical stresses acting on the components of the secondary battery when they are in operation, so that the alkali metal secondary battery has high long-term stability and high operational reliability.

One reason for the high specific capacity, high power density and cycle stability are the pores of the first type. The pores of the first type allow an efficient and reversible uptake of deposited metallic alkali metal. What is important here is the circumstance that the electrolyte of the secondary battery cannot penetrate into the pores of the first type.

In fact, the provided alkaline metal secondary battery goes back to a surprising discovery: It is known that, when an alkali metal secondary battery is discharged, metallic alkali metal is oxidized to alkali metal ions by the release of electrons. Theoretically, the thereby resulting alkali metal ions can only be efficiently taken up and diverted by the electrolyte if it is in direct contact with the alkali metal ions. In other words, if the resulting alkali metal ions lose contact with the electrolyte, the transport of alkali metal ions to the electrolyte should become very inefficient or even break off. However, the applicant has surprisingly found that this is not the case when the carbon layer described above is used. It was noted that even alkali metal ions that are generated within the pores of the first type and are remote to the electrolyte are efficiently passed on to the electrolyte via the carbon network (in particular within the pores of the first type) and that the charge transport does not break off, as expected.

The alkali metal secondary battery can be characterized in that the pores of the first type are provided with a chemical modification which favors the take-up of metallic alkali metal produced by deposition. The chemical modification is preferably selected from the group consisting of a layer on the pore surface, nanoparticles on the pore surface, at least one chemical functional group on the pore surface and combinations thereof. Furthermore, the pores of the first type can have a specific pore geometry and/or pore nature. The formation of metallic structures in the pores of the first type can be promoted by pore geometry and/or pore character. The overpotential (the energy barrier) for the separation of alkali metal from the electrolyte can thus be reduced. In microporous carbons (pore diameter <2 nm), the formation of metallic Li clusters above 0 V (vs. Li/Li+) can be observed, which indicates a decrease in the thermodynamic enthalpy of formation.

The pores of the first type can have a pore size in the range from 0.5 to 100 nm. Furthermore, the pores of the first type can have a pore size of >2 nm. The pores of the first type particularly preferably have a pore size of <2 nm, because in this case, the formation of metallic Li clusters above 0 V (vs. Li/Li+) can be observed, which indicates a lowering of the thermodynamic enthalpy of formation (see example), wherein the pore size can preferably be determined with nitrogen physisorption.

The carbon layer can further comprise pores of a second type and/or cavities which are accessible to the electrolyte. The pores of the second type provide a large contact area for the electrolyte, so that effective transport of alkali metal ions from the electrolyte to the carbon layer and back is possible, thus achieving high charge and discharge currents with excellent reversibility (cycle stability). It is important here that the electrolyte can penetrate deep into the carbon layer via the pores of the second type and thus a deposition of metallic alkali metal can also take place in deeper layers of the carbon layer of the anode, that is, in a certain way via a deep, “three-dimensional” interface having an enlarged surface compared to a “two-dimensional” interface that does not go deep. The pores of the first type also serve as “free spaces” in the deep layers of the carbon layer for the take-up of deposited, metallic alkali metal, since these pores are not filled with electrolyte. As a result of the deposition of the metallic alkali metal over a large surface and in free spaces that are not filled with electrolyte, the mechanical stress on the components of the secondary battery is significantly reduced during operation of the secondary battery. The alkali metal secondary battery according to the invention thus has a higher long-term stability and operational reliability than known alkali metal secondary batteries.

In comparison with a “two-dimensional” interface that does not go deep, the “three-dimensional” interface advantageously provides a contact surface to the electrolyte that is 2 to <100 times as large, preferably 3 to 30 times as large, particularly preferably 5 to 20 times as large, in particular 8 to 12 times as large as the “two-dimensional” contact surface to the electrolyte. A higher “three-dimensional” contact surface, for example, in the range 100-1000 times as large, would in turn be disadvantageous, since losses due to secondary reactions also occur at the interface between carbon layer and electrolyte and said losses become disadvantageous if the contact surface is too large.

The pores of the second type and/or the cavities can have a spatial extent in all three spatial directions which is in the micrometer range, in particular in the range from 1 μm to 1000 μm, the spatial extent preferably being determinable using electron microscopy.

In a preferred embodiment, the pores of the second type and/or the cavities comprise electrolyte, preferably in an entire volume of their spatial extent.

In a charged state, the carbon layer can comprise an alkali metal, preferably lithium or sodium, the alkali metal preferably being present in a proportion of 10 to 90% by weight, based on the total weight of the carbon layer.

Furthermore, in an uncharged state, it is possible that the carbon layer does not comprise any lithium or sodium, preferably no alkali metal.

In a preferred embodiment, the electrolyte is a sulfidic solid electrolyte.

However, the electrolyte can also be a liquid electrolyte or gel electrolyte, and all components of the electrolyte, in particular all molecules of the electrolyte, can have a size that exceeds the size of the pores of the first type and/or exceeds the size of pores of a protective layer arranged between the electrolyte and the porous carbon particles, the protective layer being conductive for alkali metal ions. The electrolyte preferably comprises or consists of an ionic liquid.

In a preferred embodiment, the carbon layer forms a carbon network suitable for transporting alkali metal ions along the carbon network. This means in particular that the pores of the first type are suitable for transporting alkali metal ions within the pores of the first type (for example, along the pore walls). When the alkali metal secondary battery is discharged, there is inevitably a certain distance between the alkali metal deposited in the pores and the electrolyte, which, depending on the pore size, can be several 100 nm. For a complete discharge, a complete return transport of the alkali metal stored in the pores is necessary, a complete return transport also being necessary after the oxidation of alkali metal ions stored there in the electrolyte. Such a complete return transport can only take place if the carbon network, especially the pores of the first type, is/are suitable for guiding the alkali metal ions to the electrolyte. The pores of the first type preferably have these properties, since this increases the discharge capacity of the secondary battery.

The pores of the first type of carbon layer can together have a pore volume of ≥0.5 cm³/g carbon, preferably ≥0.8 cm³/g carbon, particularly preferably ≥1.0 cm³/g carbon. A high pore volume has the advantage of a large space being provided for taking up metallic alkali metal produced by deposition, which provides high capacities and maximizes the contact area with the electrolyte, which ensures high charging and discharging currents. In addition, a large pore volume means that the weight of the secondary battery can be kept low, which is a decisive advantage especially for mobile applications (lower weight-to-power ratio).

The carbon layer can comprise micropores, mesopores and/or macropores classified according to IUPAC, preferably can comprise micropores classified according to IUPAC.

The carbon layer can be suitable for taking up metallic alkali metal produced by deposition in an amount such that the carbon layer has a specific capacity of ≥400 mAh/g, preferably ≥600 mAh/g, particularly preferably ≥800 mAh/g, in particular ≥1000 mAh/g, based on the mass of the carbon material.

The electrolyte can have an ionic conductivity σ of at least 10⁻¹⁰ S·cm⁻¹, preferably at least 10⁻⁸·S·cm⁻¹, particularly preferably at least 10⁻⁶ S·cm⁻¹, very particularly preferably at least 10⁻⁴ S·cm⁻¹, in particular at least 10⁻³ S·cm⁻¹.

In a preferred embodiment, the electrolyte has a lower conductivity for electrons than the electrically conductive substrate, or the carbon layer of the anode, and/or than the cathode; preferably it has essentially no conductivity for electrons.

The electrolyte can be designed as a foil.

Furthermore, the electrolyte from the anode in the direction of the cathode can have a maximum extension in a range from 1 μm to 100 μm, preferably 10 μm to 50 μm.

The cathode can comprise a current collector, the current collector preferably being in the form of a layer, the layer particularly preferably being in the form of a stretch layer, a layer having a double-sided coating, a layer of fiber fabric, a layer having a primer layer.

Furthermore, it is possible that the cathode does not comprise an alkali metal source, or comprises an alkali metal source, the alkali metal source preferably being present in a proportion of 60 to 99% by weight, based on the total weight of the cathode.

In addition, the cathode can comprise a solid electrolyte.

In addition, the cathode can comprise an electrically conductive additive.

Apart from this, the cathode can at least partially comprise fibrillar polytetrafluoroethylene, the at least partially fibrillar polytetrafluoroethylene preferably being present in a proportion of <1% by weight, based on the total weight of the cathode.

In a preferred embodiment, the cathode consists of the components mentioned above.

The alkali metal secondary battery may be a lithium secondary battery or a sodium secondary battery.

It is further proposed to use the alkali metal secondary battery according to the invention for a means of transport, a building and/or an electronic device, preferably as an energy source for a means of transport selected from the group consisting of automobiles, aircraft, drones, trains and combinations thereof.

The subject according to the invention is intended to be explained in more detail with the aid of the following figures and the following example, without wishing to restrict it to the specific embodiments shown here.

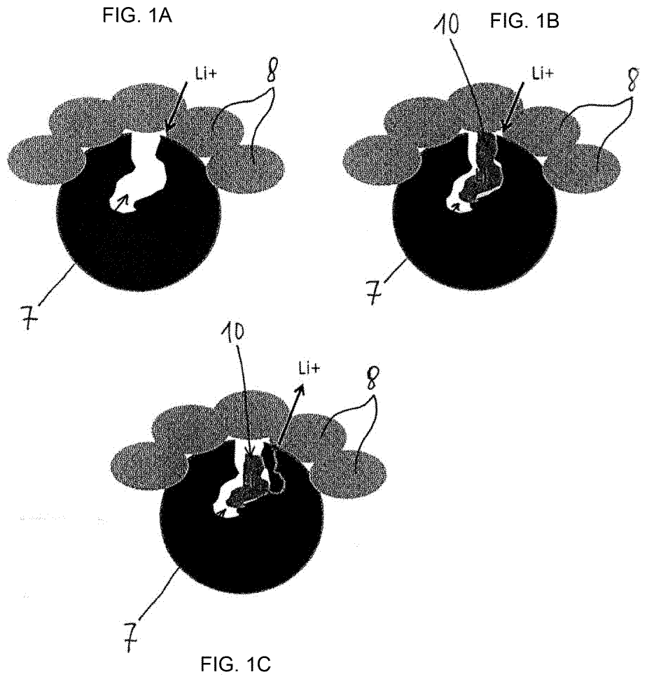

FIGS. 1A-C show schematically the processes at the interface between a carbon particle 6 of the carbon layer of the anode and the electrolyte 8 of the alkali metal secondary battery according to the invention, which is a lithium secondary battery here. In the charging process depicted in FIG. 1A, lithium ions are transported from the cathode (not shown) through the electrolyte 8 into a pore 7 of the first type of the carbon particle 6. There the lithium ions take up electrons which flow from the conductive layer of the anode (not shown) to the carbon particle 6, and are reduced to lithium metal 10, which is now located within the pores 7 of the first type. During the discharge process depicted in FIG. 1B, the metallic lithium 10 is oxidized to lithium ions by withdrawing electrons (that is, metallic lithium is dissolved) and the lithium ions can be taken up by the electrolyte and transported to the cathode. The situation depicted in FIG. 1C describes the surprising finding that even lithium metal 10, which is dissolved to lithium ions far away from the electrolyte 8, is still efficiently transported to the electrolyte 8 and from there to the cathode. An efficient transport of lithium ions along the pore 7 of the first type in the direction of the electrolyte 8 must therefore be possible.

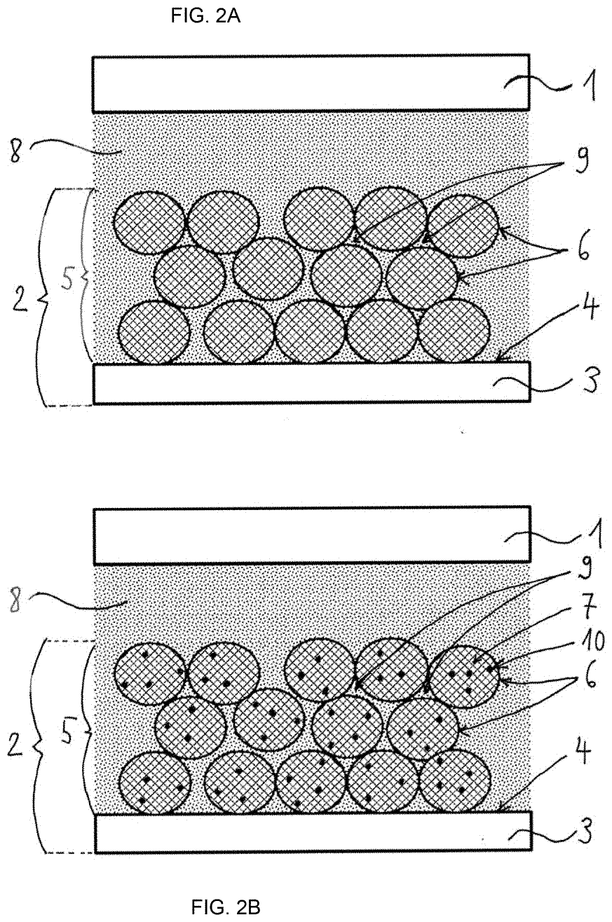

FIGS. 2A-B schematically show the structure of an alkali metal secondary battery according to the invention. In FIG. 2A, the secondary battery is depicted in the uncharged state and in FIG. 2B, the secondary battery is depicted in the charged state. The alkali metal secondary battery depicted comprises a cathode 1 and an anode 2 comprising an electrically conductive substrate 3, the electrically conductive substrate 3 extending over a certain geometrical area 4 and a carbon layer 5 being arranged at least in some regions on this area 4, the carbon layer 5 comprising carbon particles 6 having pores 7 of the first type and forming an electrically conductive contact with the electrically conductive substrate 3 of the anode 2 and with one another. The secondary battery further comprises an electrolyte 8 arranged between the cathode 1 and anode 2 and having an alkali metal ion-conductive contact with the cathode 1 and with the carbon particles 6 of the anode 2. The carbon layer 5 has pores 9 of the second type between the carbon particles 6, which pores at least in regions comprise the electrolyte 8, the pores 7 of the first type having such a small pore size that they are unsuitable for taking up the electrolyte and are suitable for taking up metallic alkali metal 10 generated by deposition. In FIG. 10, the deposition of metallic alkali metal 10 is depicted in simplified form in only a few pores 7 of the first type.

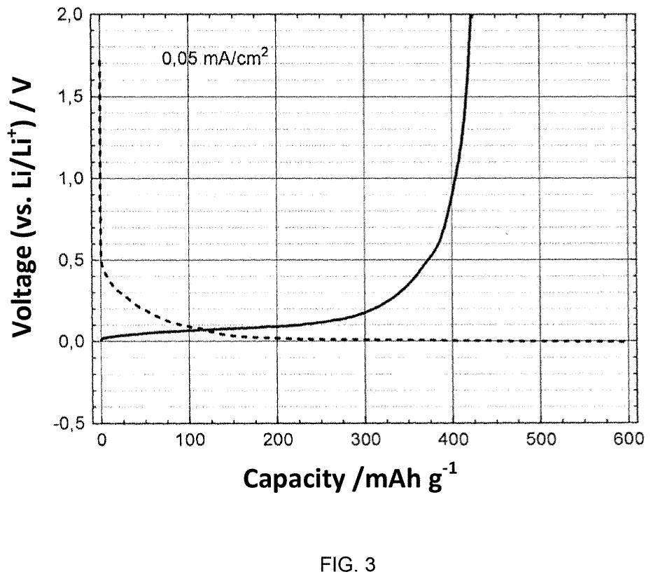

FIG. 3 shows the result of an experiment carried out with an alkali metal secondary battery (lithium secondary battery) according to the invention. The voltage profile for the lithiation is depicted in dashed lines and the voltage profile for the delithiation is depicted as a solid line. The lithium secondary battery was a half-cell having an anode described in claim 1, a lithium metal foil as the cathode and a sulfidic solid electrolyte. The lithiation or delithiation took place at a constant current of 0.05 mA/cm². The specific capacity of the delithiation was determined to be 423 mAh/g.

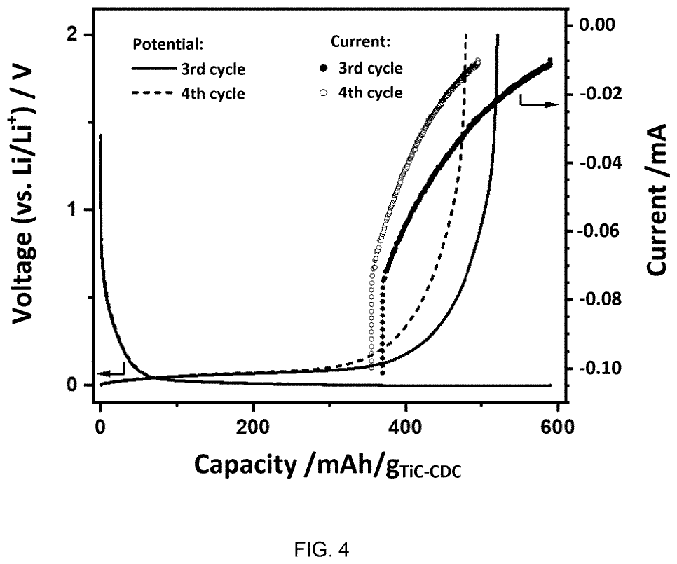

FIG. 4 shows the resulting potential profiles of the third and fourth cycle of lithiation and delithiation for the TiC-CDC cell from the example. A reversible lithiation capacity of 521.0 mAh/gTiC-CDC could be observed in the third cycle of the half-cell.

### Example—Capacity of an Alkali Metal Secondary Battery According to the Invention

All material treatments were carried out under inert gas.

First, the carbon material TiC-CDC was dried for 12 h at 200° C. under inert gas conditions. This carbon material has pores of the first type having a pore size of <2 nm, the pore size being determinable with nitrogen physisorption.

To produce a powdery composite electrode (anode), the dried TiC-CDC was then manually mixed i) with carbon nanofibers (VG-CNF) grown from the gas phase, ii) with a conductive carbon additive and iii) with a solid electrolyte (Li6PS5Cl=SE) in an agate mortar for 30 minutes in a mass ratio of 60:5:35.

A half-cell was then produced in a stainless steel outer casing having a Teflon liner using a die having a diameter of 13 mm. For this purpose, a Li foil having a diameter of 13 mm and a thickness of 50 μm (counter electrode) was arranged in the die and 150 g of solid electrolyte powder (Li6PS5Cl powder=SE powder) was evenly distributed thereon using a micro spatula. This composition was compressed and compacted into a pellet.

Then the TiC-CDC composite powder (7.44 mg) (test electrode) was distributed homogeneously over the compacted solid electrolyte surface in the die and compacted again using a hydraulic press with 4 tons for 30 s. The resulting active material stressing of the cell was 3.36 mg/cm′.

The electrochemical behavior of the cell was measured with a battery tester VMP3 (BioLogic, France). Here, at a constant temperature of 25° C., the reversible capacity of the anode (having the carbon layer according to the invention) was tested against the counter electrode (lithium metal foil) at potentials above 0 V and at potentials of 0 V (vs. Li/Li+).

Various cycles were carried out, with the lithiation of the carbon-active material of the carbon layer to 0 V with a subsequent step with constant voltage at 0 V until the current exceeds −0.01 mA, and the delithiation of the carbon-active material of the carbon layer to 2 V. The applied current was 0.065 mA.

The resulting potential profiles of the third and fourth cycle of lithiation and delithiation for the TiC-CDC cell are depicted in FIG. 4. A reversible lithiation capacity of 521.0 mAh/gTiC-CDC could be observed in the third cycle of the half-cell.

### LIST OF REFERENCE SYMBOLS

1: cathode;
2: anode;
3: electrically conductive substrate of the anode;
4: extension over a certain geometric area;
5: carbon layer;
6: carbon particles;
7: pores of the first type of the carbon layer;
8: electrolyte;
9: pores of the second type of the carbon layer;
10: metallic alkali metal produced by deposition (for example, lithium) in pores of the first type.

1-16. (canceled)

17. An alkali metal secondary battery comprising:
a) a cathode;
b) an anode comprising a carbon layer, the carbon layer alone, or in combination with an electrically conductive substrate, forming an electrically conductive contact; and
c) an electrolyte arranged between the cathode and anode and having an alkali metal ion-conductive contact to the cathode and to the carbon layer of the anode;
wherein the carbon layer comprises pores of a first type which are not accessible to the electrolyte and which are suitable for taking up electrochemically deposited alkali metal in metallic form during a charging process of the alkali metal secondary battery.

18. The alkali metal secondary battery according to claim 17, wherein the pores of the first type are provided with a chemical modification which favors the uptake of metallic alkali metal generated by deposition.

19. The alkali metal secondary battery according to claim 18, wherein the chemical modification is selected from the group consisting of a layer on the pore surface, nanoparticles on the pore surface, at least one chemical functional group on the pore surface, and combinations thereof.

20. The alkali metal secondary battery according to claim 17, wherein the pores of the first type have a pore size
i. in the range of 0.5 to 100 nm;
ii. of >2 nm; or
iii. of <2 nm.

21. The alkali metal secondary battery according to claim 17, wherein the carbon layer further comprises pores of a second type and/or cavities that are accessible to the electrolyte, wherein the pores of the second type and/or the cavities have a spatial extent in all three spatial directions which is in the micrometer range.

22. The alkali metal secondary battery according to claim 17, wherein the pores of the second type and/or the cavities comprise electrolyte.

23. The alkali metal secondary battery according to claim 17, wherein the carbon layer,
i) in a charged state, comprises an alkali metal, and/or
ii) in an uncharged state, does not comprise any lithium or sodium.

24. The alkali metal secondary battery according to claim 17, wherein the electrolyte is a sulphidic solid electrolyte.

25. The alkali metal secondary battery according to claim 24, wherein the sulphidic solid electrolyte is selected from the system Li2S—P2S5, Li2S—GeS2, Li2S—B2S3, Li6PS5Cl, Li2S—SiS2, Li2S—P2S5-LÎX (X=Cl, Br, I), Li2S—P2S5—Li2O, Li2S—P2S5—Li2O—LiI, Li2S—SiS2—LiI, Li2S—SiS2—LiBr, Li2S—SiS2—LiCl, Li2S—SiS2—B₂S3—LiI, Li2S—SiS2—P2S5—LiI, Li2S—P2S5-ZmSn, where m and n are integers and M is selected from P, Si or Ge, Li2S—SiS2—Li3PO4, Li2S—SiS2—LipMOq, where p and q are integers and M is selected from P, Si or Ge, Na2S—P2S5, Na2S—GeS2, Na2S—B2S3, NaePSsCl, Na2S—SiS2, Na2S—P2S5—NaX (X=Cl, Br, I), Na2S—P2S5—Na2O, Na2S—P2Ss-Na2O—NaI, Na2S—SiS2—NaI, Na2S—SiS2—NaBr, Na2S—SiS2—NaCl, Na2S—SiS2—B2Ss-NaI, Na2S—SiS2—P2Ss-NaI, Na2S—P2S5-ZmSn, where m and n are integers and M is selected from P, Si or Ge, Na2S—SiS2—Na3PO4, Na2S—SiS2—NapMOq, where p and q are integers and M is selected from P, Si or Ge, or a mixture thereof.

26. The alkali metal secondary battery according to claim 17, wherein the electrolyte is a liquid electrolyte or gel electrolyte, and all components of the electrolyte, have a size which
i) exceeds the size of the pores of the first type; and/or
ii) exceeds the size of pores of a protective layer arranged between the electrolyte and the porous carbon particles, wherein the protective layer is conductive for alkali metal ions.

27. The alkali metal secondary battery according to claim 17, wherein the carbon layer forms a carbon network suitable for transporting alkali metal ions along the carbon network.

28. The alkali metal secondary battery according to claim 17, wherein the carbon layer
i) comprises pores of the first type which together have a pore volume of ≥0.5 cm³/g carbon; and/or
ii) comprises micropores, mesopores and/or macropores classified according to IUPAC.

29. The alkali metal secondary battery according to claim 17, wherein the carbon layer is suitable for taking up metallic alkali metal produced by electrochemical deposition in an amount such that the carbon layer has a specific capacity of ≥400 mAh/g, based on the mass of the carbon material.

30. The alkali metal secondary battery according to claim 17, wherein the electrolyte
i) has an ionic conductivity a of at least 10⁻¹⁰ S·cm⁻¹; and/or
ii) has a lower conductivity for electrons than the electrically conductive substrate of the anode and/or than the cathode.

31. The alkali metal secondary battery according to claim 17, wherein the electrolyte
i) is designed as a foil; and/or
ii) from the anode in the direction of the cathode, has a maximum extension in a range from 1 μm to 100 μm, preferably 10 μm to 50 μm.

32. The alkali metal secondary battery according to claim 17, wherein the cathode
i) comprises a current collector;
ii) does not comprise an alkali metal source, or comprises an alkali metal source;
iii) comprises a solid electrolyte;
iv) comprises an electrically conductive additive; and
v) at least partially comprises fibrillar polytetrafluoroethylene.

33. The alkali metal secondary battery according to claim 17, wherein the alkali metal secondary battery is a lithium secondary battery or a sodium secondary battery.
